(19) United States
(12) Patent Application Publication
(10) Pub. No.: US 2006/0286521 A1
(43) Pub. Date: Dec. 21, 2006

(54) System and method for out of area behavior modification in schools

(76) Inventor: James Clark, St. Louis, MO (US)

Correspondence Address: HARNESS, DICKEY, & PIERCE, P.L.C, 7700 BONHOMME, STE 400, ST. LOUIS, MO, 63105, US

(21) Appl. No.: 11/153,118

(22) Filed: Jun. 15, 2005

(51) Int. Cl. G09B 19/00; G09B 25/00

(52) U.S. Cl. 434/238; 434/365

(57) ABSTRACT

A system and method for a method for addressing disruptive behavior of a student includes evaluating a student's behavior against a set of out of area behavior criteria, designating the student for placement in an out of area program as a function of the evaluation of the student's behavior, and placing the designated student in the out of area program for a placement period. The method also includes evaluating the performance of the placed student during the out of area program, and removing the placed student from the out of area program when the student's evaluation is equal to a removal threshold.

### FIELD OF THE INVENTION

The present invention relates to educational systems and methods, and more specifically the invention relates to a method and system for addressing student behavioral problems.

### BACKGROUND OF THE INVENTION

Educators currently have a variety of education aids and methods available to them to assist in motivating and instructing students. Many of these educational aids include books, charts, games, or policy and procedures that provide students with knowledge and feedback with regard to their accomplishments.

Additionally, disciplinary aids and methods typically provide for management by the teacher or other school staff member and include behavioral records and disciplinary policies and procedures that include in school suspension, out of school suspension, and expulsion. Behavioral modification systems and methods often do not provide the teacher or educator with the ability to objectively identify behavioral incidents, do not provide for a standardize method or treatment of student incidences, or warn the student of pending discipline scenarios. These systems and methods typically fail as they are costly to administer, often remove the student from the educational process, and result in the loss of learning experience and loss of revenue to the school.

As such, the inventor of the current invention has invented a system and method for identifying and evaluating disruptive behavior in students, addressing the disruptive behavior when it occurs, and motivating a student to improve his/her behavior and attitude while in school.

### SUMMARY OF THE INVENTION

The inventor hereof has succeeded at designing various embodiments of the invention that include a system and method for schools, and in particular secondary middle schools, to address disruptive and/or disrespectful behavior by both regular and special education students. In one respect, the invention can be considered a behavioral modification system and method to address student behavioral problems. In another respect, the invention can be considered a partial or all-school behavior modification program and system for public or private schools.

The system and method provides, at least in part, for empowering school staff and holding both regular and special education students accountable for their inappropriate behaviors during the school day. The invention can include the identification or targeting of “out of area” behavior incidences by students since the inventor hereof has discovered that obtaining and tracking the location of students is one key to minimizing discipline problems in a school. These out of area incidences and areas can be associated with student behavioral problems. As will be addressed in greater detail, however, the inventor has identified that many behavioral problems such as tardiness, insubordination, play fighting, vandalism, stealing, inappropriate touching, and assaults, are associated with the student or students being in an inappropriate or unauthorized area, e.g., out of the area where he or she is supposed to be at the time. As such, a school can control behavior by controlling and disciplining students when they are found to be out of area, even though a behavioral problem may not have yet occurred.

Various aspects of the invention herein can have many advantages. These can include saving the school money by reducing or eliminating for after school or weekend detentions, save costs associated with in-school and out-of-school suspension programs, increase revenue by keeping the students in school, and improves student's discipline. Additionally, this can improve the overall educational opportunity received by each of the attended students as well as the other students in the school and class. This can also improve the teaching satisfaction or moral for the teachers and administrator as it removes some of the disciplinary responsibility for disruptive students and provide an easy referral and/or behavior modification option for the teachers. This can also improve parental and community support for the school. As noted, the out of area program can, in some embodiments, be a behavioral modification program that assists school administrators and staff when they are confronted with disruptive and/or disrespectful students. Additionally, students become more involved and are confronted with the consequences of the behavioral or poor choices, but are kept at school and in a learning environment, rather than sent home on suspension. These and the other students can in turn focus on expected school behavior within the school established rules, which preferably are well known to the students.

According to one aspect of the invention, an educational system for evaluating a student for placement in an out of area program includes a computer having a processor, a memory, an input device, and a reporting component and a means for evaluating a student's behavior against a set of out of area behavior criteria. The system also includes means for preparing an out of area referral as a function of the evaluating. The computer is configured to receive and store the prepared out of area referral, sum a plurality of the stored out of area referrals for the student, compare the summed out of area referrals for the student against an out of area program threshold, and designate the student for placement in an out of area program as a function of the summed out of area referrals being equal to or greater than the out of area program threshold.

According to another aspect of the invention, an educational system for addressing disruptive behavior of a student includes a computer having a processor, a memory, an input device, and a reporting component and a means for evaluating a student's behavior against a set of out of area behavior criteria. The system also includes means for preparing an out of area referral as a function of the means for evaluating, means for placing the designated student in the out of area program for a placement period. The system further includes means for evaluating the performance of the placed student during the out of area program and means for removing the placed student from the out of area program when the student's evaluation is equal to a removal threshold. The computer is configured to receive and store the prepared out of area referral, sum a plurality of the stored out of area referrals for the student, compare the summed out of area referrals for the student against an out of area program threshold, and designate the student for placement in an out of area program as a function of the comparing the summed out of area referrals being equal to or greater than the out of area program threshold.

According to yet another aspect of the invention, a method of evaluating a student for placement in an out of area program includes evaluating a student's behavior against a set of out of area behavior criteria, preparing an out of area referral as a function of the evaluating, and storing the prepared out of area referral. The method also includes summing a plurality of the stored out of area referrals, comparing the summed out of area referrals for the student against an out of area program threshold, and designating the student for placement in an out of area program as a function of the summed out of area referrals being equal to or greater than the out of area program threshold.

According to still another aspect of the invention, a method for addressing disruptive behavior of a student includes evaluating a student's behavior against a set of out of area behavior criteria, designating the student for placement in an out of area program as a function of the evaluation of the student's behavior, and placing the designated student in the out of area program for a placement period. The method also includes evaluating the performance of the placed student during the out of area program, and removing the placed student from the out of area program when the student's evaluation is equal to a removal threshold.

According to still another aspect of the invention, a method of motivating a student to improve behavior and attitude includes establishing an out of area behavior criteria, evaluating a student's behavior against the out of area behavior criteria, and preparing an out of area referral as a function of the evaluating. The method also includes tracking the out of area referrals for the student, recognizing a student for receiving fewer out of area referrals over a recognition time period than a recognition quantity, and designating the student for placement in an alternative lunchroom program as a function of the tracking of the out of area referrals. The method further includes placing the designated student in the alternative lunchroom program for a placement period, evaluating the performance of the placed student during the alternative lunchroom program, and removing the placed student from the alternative lunchroom program when the student's evaluation is equal to a removal threshold.

Further aspects of the present invention will be in part apparent and in part pointed out below. It should be understood that various aspects of the invention may be implemented individually or in combination with one another. It should also be understood that the detailed description and drawings, while indicating certain exemplary embodiments of the invention, are intended for purposes of illustration only and should not be construed as limiting the scope of the invention.

### BRIEF DESCRIPTION OF THE DRAWINGS

FIG. 1 is a flow chart of a method of evaluating students for placement in an out of area program according to a first exemplary embodiment of the invention.

FIG. 2 is a flow chart of a method for addressing disruptive behavior of a student according a second exemplary embodiment of the invention.

FIG. 3 is an a flow chart of a method of motivating a student to improve behavior and attitude according to a third exemplary embodiment of the invention.

FIG. 4 is an out of area referral form according to some embodiments of the invention.

FIG. 5 is a hall pass form according to some embodiments of the invention.

FIG. 6 is a quiz form for testing a student's knowledge of the out of area program according to some embodiments of the invention.

FIG. 7 is a weekly award and/or recognition acknowledgement form according to some embodiments of the invention.

FIG. 8 is a student out of area contract form according to some embodiments of the invention.

FIG. 9 is an all school notice form for providing notice to school staff of students placed on the out of area program according to some embodiments of the invention.

FIG. 10 is an out of area student checklist according to some embodiments of the invention.

FIGS. 11A to 11E are out of area attendance and scoring forms for a five week period according to some embodiments of the invention.

FIG. 12 is a block diagram of an exemplary educational system having a computer for implementing one exemplary embodiment of the present invention.

Like reference symbols indicate like elements or features throughout the drawings.

### DETAILED DESCRIPTION OF EXEMPLARY EMBODIMENTS

The following description is merely exemplary in nature and is in no way intended to limit the invention, its applications, or uses.

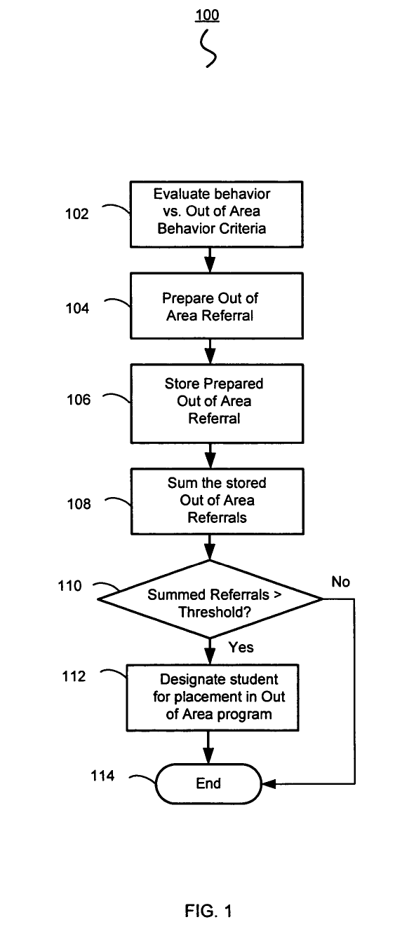

In one embodiment of the invention as illustrated by way of one exemplary embodiment in FIG. 1, a method 100 for evaluating a student for placement in an out of area program includes evaluating a student's behavior against a set of out of area behavior criteria 102, preparing an out of area referral as a function of the evaluating 104, and storing the prepared out of area referral 106. The method also includes summing a plurality of the stored out of area referrals 108, comparing the summed out of area referrals for the student against an out of area program threshold 110, and designating the student for placement in an out of area program as a function of the summed out of area referrals being equal to or greater than the out of area program threshold 112. The method loops to the end in 114 if the summed referrals is less than the threshold, and the method 100 is repeated (not shown)

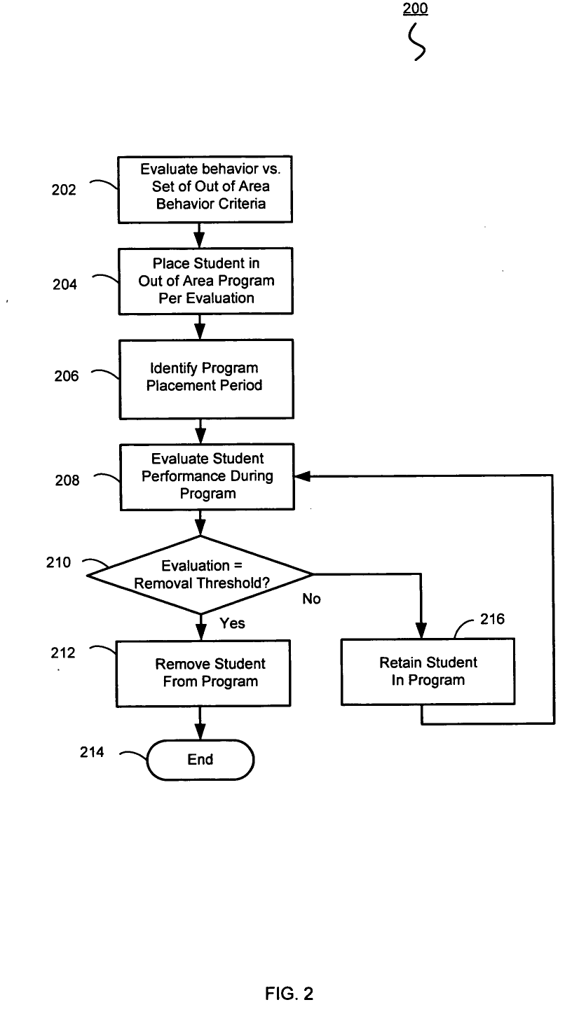

Referring now to FIG. 2, in n another embodiment, a method 200 for addressing disruptive behavior of a student includes evaluating a student's behavior against a set of out of area behavior criteria 202, designating the student for placement in an out of area program as a function of the evaluation of the student's behavior (not shown), and placing the designated student in the out of area program for a placement period 204. The method also includes evaluating the performance of the placed student during the out of area program (208), and removing the placed student from the out of area program when the student's evaluation is equal to a removal threshold 212 or retains the student in the program 216. The process ends in 214 and/or loops back to the beginning (not shown).

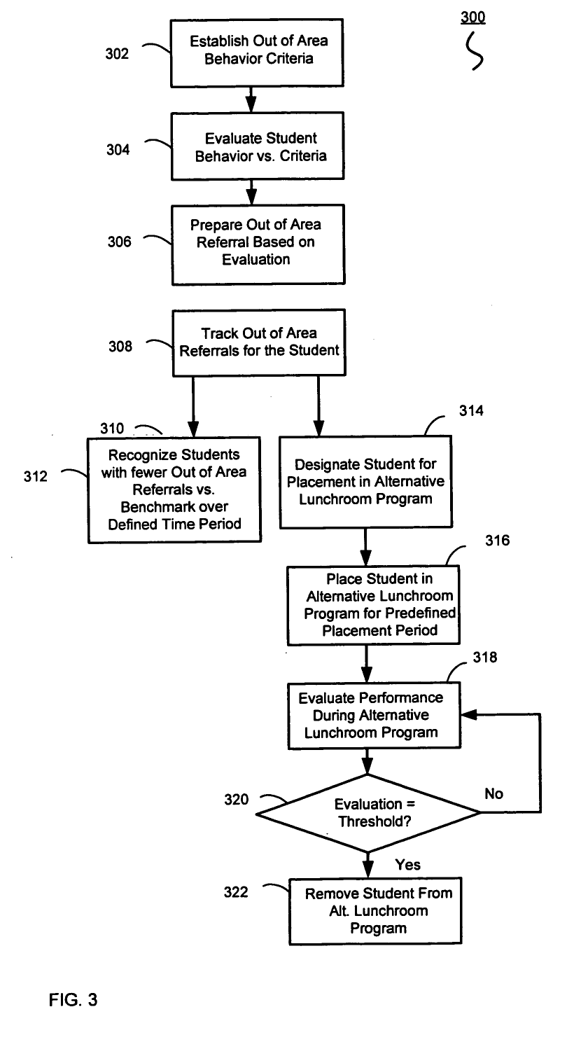

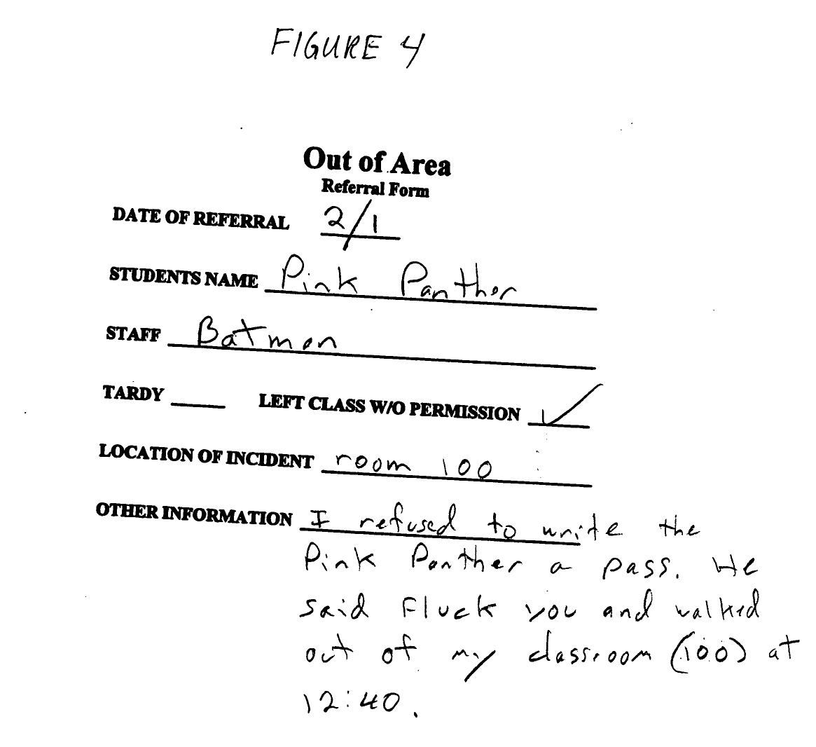

Referring now to FIG. 3, in another embodiment a method 300 for motivating a student to improve behavior and attitude includes establishing an out of area behavior criteria 302, evaluating a student's behavior against the out of area behavior criteria 304, and preparing an out of area referral as a function of the evaluating 306. The method also includes tracking the out of area referrals for the student 308, recognizing a student for receiving fewer out of area referrals over a recognition time period than a recognition quantity 310 and 312, and designating the student for placement in an alternative lunchroom program as a function of the tracking of the out of area referrals 314. The method further includes placing the designated student in the alternative lunchroom program for a placement period 316, evaluating the performance of the placed student during the alternative lunchroom program 318, and removing the placed student from the alternative lunchroom program when the student's evaluation is equal to a removal threshold 320 and 322.

### Embodiments of Implementation

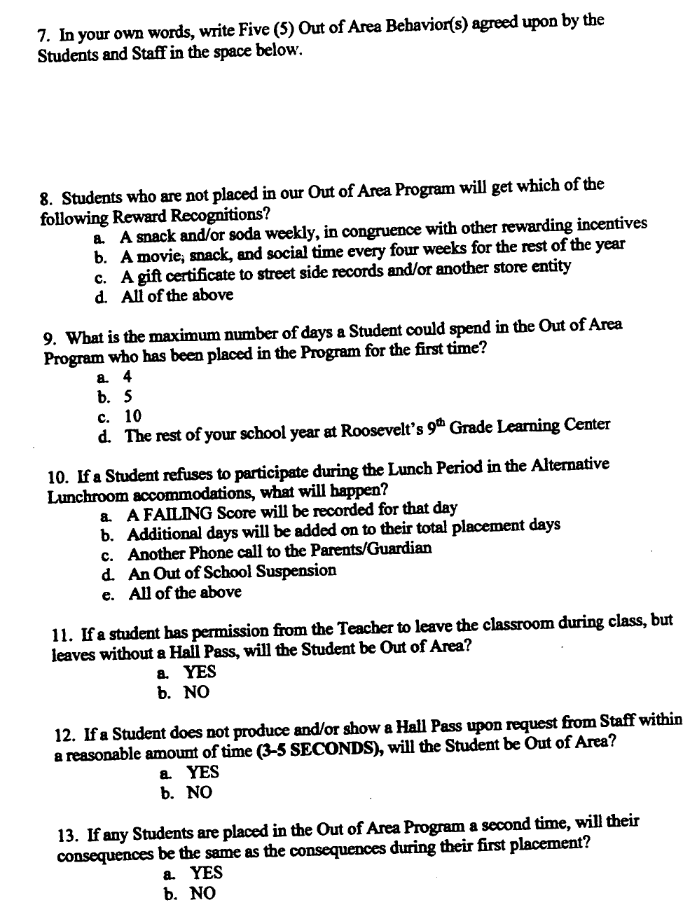

The out of area program is implemented after all staff members including all teachers have provided input into the programs design and implementation and have been trained. Additionally, the students and their parents or guardians are made aware of the out of area program. In one embodiment, students are required to attend a seminar or information presentation of the out of area program and receive a passing grade or 100 percent passing of a quiz (see FIG. 6 by way of example) regarding the out of area program to verify and document their understanding of the out of area program. As shown in FIG. 6 a list of questions reviews an out of area program and when reviewed and completed by the student will acknowledge and indicate the students knowledge and recognition of the out of area program.

Additionally, tutoring with regard to the out of area program can be provided to students failing to attend the seminar or failing to obtain a passing grade on the out of area quiz. For example, in one preferred embodiment each student should obtain score of 100 percent on the out of area quiz before the student will be released from the out of area student training program. All student quizzes can be retained for future reference by administrators or designated staff and verification of student knowledge, which saves time.

Various embodiment of the out of area program can also include an Alternative Lunchroom consequence or program is not described. At the start, the method and system described here will require implementation by the schools. This will include education of the teachers and staff as to the content, structure, and policies of the out of area program. The teachers and staff can also develop their own criteria for out of area behavior which will be utilized in the evaluation of students and incorporated into the program. The policies can also be modified slightly. The new hall pass and related procedures will be included in the training. An out of area coordinator can obtain the necessary supplies as will be discussed below and coordinate the education of the students and their parents/guardians. This can include administering the out of area quizzes and sending letters to the parent/guardians. Additionally, school handbooks, policy and procedures should be updated to describe the out of area program and possibly a letter to each parent and guardian should be sent at the initial implementation of the out of area program.

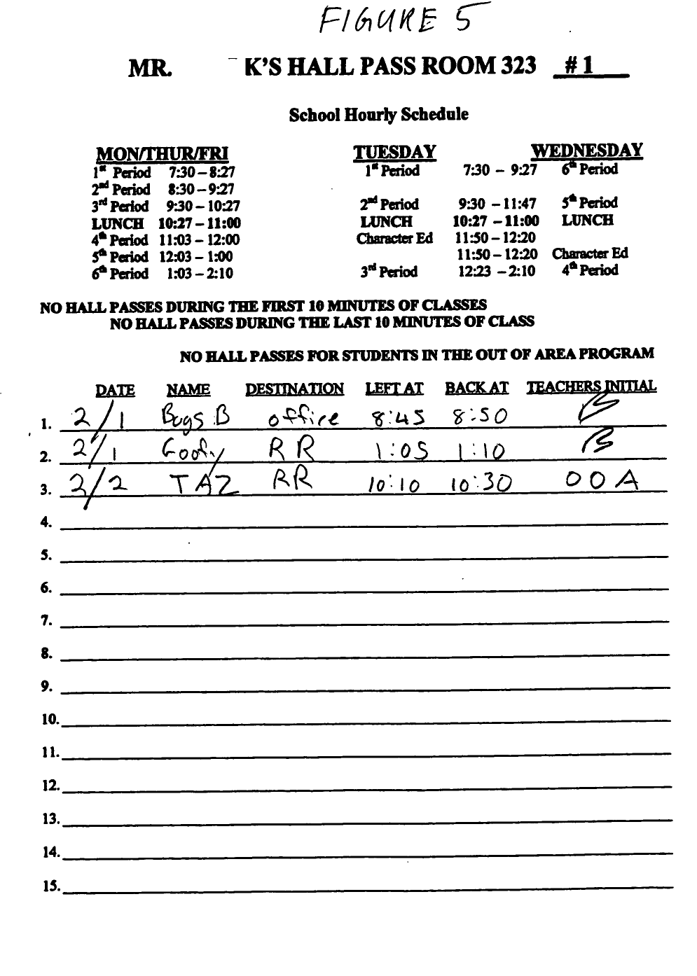

After implementation, in some embodiments the invention provides for evaluating out of area (out of area) behavior instance on a daily basis and preparing an out of area referral or evaluation form. One such example of an out of area referral form is illustrated in FIG. 4. In this example of an out of area referral form, the student Pink Panther was observed by the staff Batman as having left classroom 100 without permission. Batman noted that he had refused to write the student Pink Panther a pass. Pink Panther responded with a verbal vulgarity and walked out of the classroom at 12:40. This is just one example of a teacher's preparation of an out of area incident.

An out of area behavior incident can be any incident or act or situation that the school administration or a teacher may define. For example, out of area behavior can include, and is not limited to, the following exemplary description.

Out of area behavior therefore can, in some embodiments, include one or more categories of incidences. For example, in one embodiment two categories of incidences can include incidences while on school property and incidences associated with a special event.

Out of area while on school property can include, but is not limited to, tardiness to class, leaving a classroom early or without permission, disturbing a classroom or other learning environment or on the way to a school related destination, entering a designated out of area location of a school or classroom without permission, or failure to present a hall pass within a reasonable period of time. In one embodiment, a reasonable period of time for presenting a hall pass can be 3 seconds after being requested by a staff member. Out of area during a special event can include walking or moving inappropriately, leaving an assigned area or location during a special event, breaking or vandalizing property during the special event, etc.

By way of example, in one embodiment inappropriate behavior for students at a school can be controlled by controlling “out of area” behavior such that many other behavioral violations will be eliminated. However, in some situations, such as when a student hits or fights with another student, suspension may still be required and an out of area referral would not be necessary.

For example, “out of area” behavior while on school property can include one or more of the following in addition to other similar or related behavior:
1. Tardy to class as explained by each teacher to each class.
2. Leaving a classroom during the class period without permission.
3. Entering the hallway before the dismissal bell rings. Teachers may want to label/mark the exact classroom area boundary. This will reduce and/or possibly eliminate questions/negotiations regarding student's knowledge of exact areas.
4. In the halls during class periods without an authentic pass.
5. Disappearing for an extended period of time when given a hall pass. An example of this “out of area” behavior would be a student out of class for 5 minutes or longer when given a pass to use the restroom.
6. One or no more than two designated “out of area” locations in the classroom. A designated area such as, but not limited to, a perimeter such as one marked around the teacher's desk, computer, and/or cabinet could each be considered “out of area”.
7. If a student who belongs somewhere else enters a classroom and/or comes within a close proximity of the classroom entrance, they will/could be considered “out of area.”
8. All clocks will need to be synchronized so that everybody (staff and students) know when and/or if a student is “out of area.”
9. If a student refuses to submit their hall pass in a timely manner (in 3 to 5 seconds), this will be considered “out of area”.
10. If a student leaves a time out area before they are dismissed.
11. If a student refuses to move into an assigned seat.

Examples of “out of area” behaviors during special events can include one or more of the following:
1. Out of seat behaviors in the auditorium during presentations.
2. Out of assigned area when off school property such as on a field trip or at a school sponsored function or athletic event.
3. Entering a “location/room” other than the designation “special event” stated on the hall pass and/or on route to “special event” accordingly.
4. When dismissed from class by the intercom or letter to attend an event such as, but not limited to, ROTC, Red Cross training, athletic meeting, and/or meeting with the counselors/others in the library, students will be held accountable for their actions.

In other embodiments and implementation of the invention, other out of area instances can be by the implementing school administration.

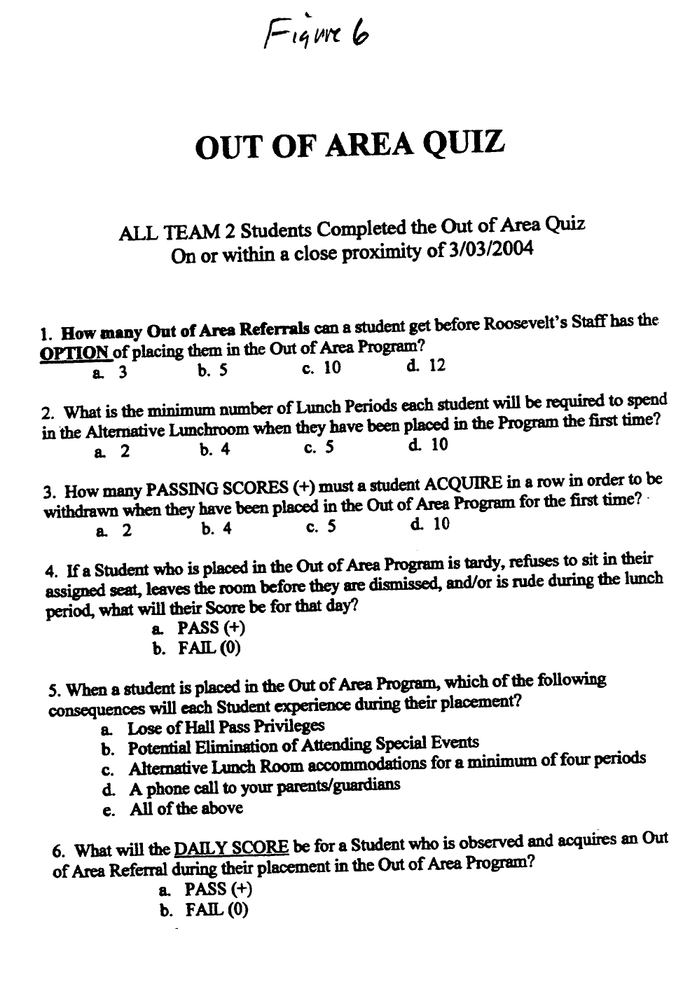

One tool that can also help in the evaluation of students is an out of area hall pass. One embodiment of the out of area hall pass is illustrated in FIG. 5. In this exemplary embodiment, Mr. K who is a teacher is provided a hall pass having 15 hall pass lines. After this pass is filled up, it is turned in to an out of area administration or coordinator and another hall pass obtained. In the example of FIG. 5, Mr. K has provided the hall pass to three students, and the destination and return times have been logged and indicated by the teacher's initials.

Classroom teachers can issue out of area hall passes to students under a variety of situations, including, but not limited to, the student going to a restroom, drinking fountain, an office, a locker, or performing an administrative duty on behalf of the student, the teacher, or another teacher. out of area hall passes should not be issued to students who are placed in the out of area program, who are tardy, act up in class, are obnoxious during the class period, and/or demonstrate unsatisfactory school or work performance.

In one embodiment, the out of area hall pass is oversized such that they are clearly visible while the student is in possession of the out of area hall pass. In another embodiment, the out of area hall pass is large such as a clip board or larger size such that it cannot be hidden or placed in a locker. In other embodiments, each out of area hall pass used in a school can be designated by a color or other indication as to the origin such as a floor or wing in a school, a grade level, and/or a team. Other visual indicators can also be utilized to clearly indicate a restriction or use of a pass by a student in order to enable school staff to easily identify whether the student is within an authorized area or out of area.

Hall passes can be used as a tool to modify a students' behavior. Hall passes are or can be a major headache for teachers. Hall passes are often used by staff when they don't want students in their classrooms. When these students acquire a hall pass, they have permission to roam the halls and disrupt other classrooms. When most students ask for a hall pass to use the restroom, go to their locker, and/or get a drink of water, they don't need to use the restroom, go to their locker, and/or get a drink of water. These students want a hall pass to meet their friends, interrupt other classrooms, and/or play in the halls.

Hall passes should be given only to students who have earned them. If a student is on time to class, completes the assigned work, behaves accordingly, and supports the teacher's requests have earned a hall pass. Students who are, but not limited to, late to class, sleeping, not working on the assignment, and/or are not following directions, should not be rewarded with a hall pass. Also, according to the “out of area” program, students who are placed in the “out of area” program lose the privilege of acquiring hall passes.

Student planners should no longer used for hall passes once the “out of area” program has been initiated. Each classroom can utilize a distinctively noticeable clipboard, which will be used to contain the designated hall pass. FIG. 5 is a sample hall pass.

As educators, our objective should be to keep the students in the classroom and out of the halls. Student evaluations (such as MAP) and all other test scores will only suffer when they spend classroom time playing in the halls. Students should earn their hall pass. The following “hall pass” policies will be implemented and used for the “out of area” program.
1. Hall passes should not be issued to students during the first 10 minutes of each class period. When students complain, show them the times at the top of the pass.
2. Hall passes should not be issued to students during the last 10 minutes of each class period.
3. One student should acquire the classroom hall pass at a time. The hall pass could be used as a competitive tool to promote productivity.
4. Students should acquire one hall pass per class period.
5. Teachers or students fill out the date, their name, destination, and the correct time they departed and arrived back to class.
6. If the nurse, another staff person, and/or the secretary are the destination, the appropriate staff should sign their initials in the appropriate destination area.
7. Upon the students return to class, staff should acknowledge the accuracy of the entries. If students' entries are invalid, remind them the next time they ask for a pass and don't give them one, submit an out of office referral and indicate such to the student.
8. Staff to include, but not limited to, the nurse, administration, secretaries, librarian, counselors, coaches and teachers should become aware of and initial all passes.
9. Students will not be allowed to have a hall pass while they are placed in the “out of area” program.
10. For support, an administrative or other designated authoritative person should be in charge of distributing and collecting all hall passes, as each hall pass can be collected a coordinator for review and control.

The method also includes identifying or determining when a student accumulates a predetermined number of out of area referrals or negative behavior evaluations. This could be also based on a time period or for a particular or defined period of time.

Reviewing the out of area incident report for compliance with out of area behavior guidelines and verifying the out of area incident report is a valid out of area incident.

In other embodiments of the invention, the out of area program can include celebrating and/or recognizing students that receive less than a predetermined recognition number of out of area referrals during a predetermined recognition time frame. Students who acquire no or few out of area referrals can be recognized and in some cases may receive an award. Recognition may also be given to students who have shown an improvement or improved record. Criteria for recognition awards can be developed by the administration or staff.

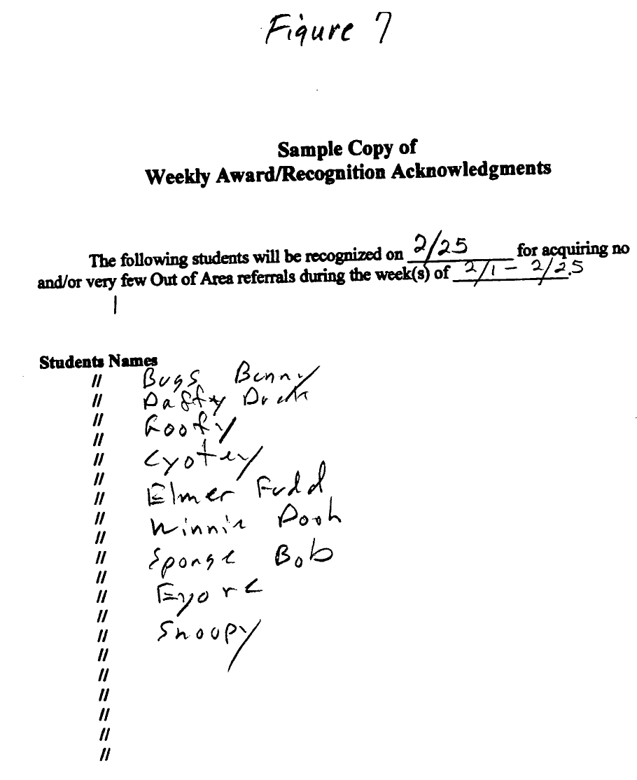

The positive recognition and/or enjoyable awards that can be provided to students who do not receive or receive fewer referrals than a predetermined number of referrals. This could be for a particular period of time, such as a semester, a term, a school year, or multiple school years. For example, as shown in FIG. 7 a weekly award and recognition acknowledgement identifies on February 25th nine students for their good behavior during the period between February 1 and 25th.

In one exemplary embodiment students who receive few and/or no out of area referrals during a predefined time period will be recognized and rewarded under such a program. In this example, three levels of awards can be provided. These include a first level that is made on a weekly basis, such as every Friday. At this level, students who are not placed in the out of area program during the preceding week receive a small gift such as a soda, candy, and/or other item of interest that may be deemed appropriate by the school administrator. In one embodiment, such recognition is provided during the last period or last 20 minutes on Friday afternoon, thereby generating a positive feedback to students as they enter the weekend.

A second level would be a monthly recognition for students receiving no or few out of area referrals. In one exemplary embodiment, every four weeks students who have not been placed tin the out of area program during the preceding four weeks are allowed to attend a school sponsored social function during the last period on Friday. This could include an ice cream social or other similar social event for students.

A third level would be at the end of the quarter or semester. At this level, all students who were not placed in the out of area program will be recognized by being presented with a Gift Certificate from a desired or student favorite retail establishment. In this case, the gift certificate could be, at least in part, sponsored by the retail establishment. Examples would include an audio store, an ice cream store, and a fast food restaurant.

Finally, at the end of the school year, students who are not placed in the out of area program and/or do not receive any out of area referrals, can be presented with a more substantial gift or reward. These may include, but are not limited to, a bike, a boom box, and or other incentive aware suitable for the occasion and as determined and funded.

Students are notified when they have acquired a number of out of area referrals that is less than a predetermined number of out of area referrals and requesting and obtaining their consent as to the pending placement in an out of area program such as an alternative lunchroom program.

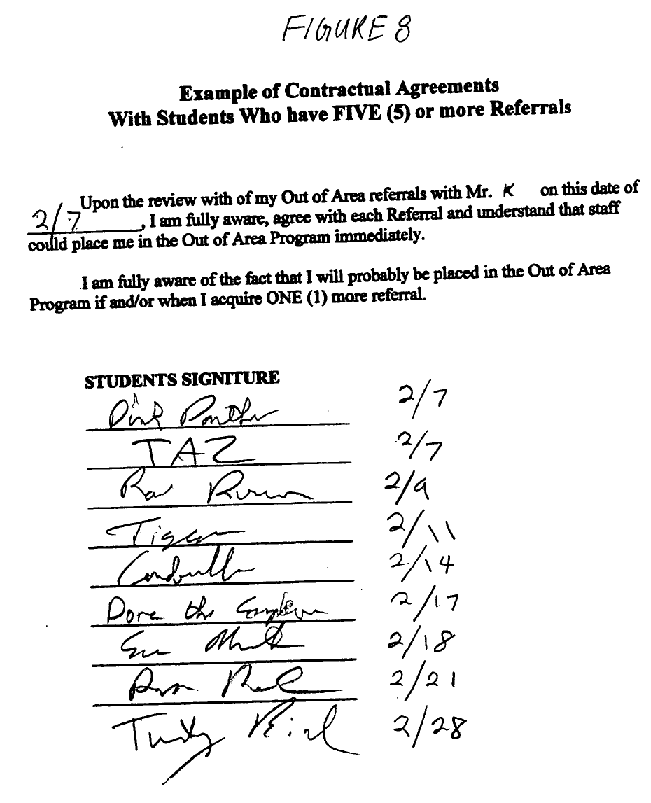

FIG. 8 illustrates a sample or example of a Student Contract in this regard.
1. Each student acknowledges the pending placement in out of area program
2. Suspension or elimination of hall pass privileges
3. Restricting attendance to special events. Supervising staff should authorize the placed student's attendance at all special events during the placement period of the student. Communicating with a parent or guardian the status of placement in the out of area program and/or conferencing with parent or guardian
4. Communicate verbally to the student at least one day before the beginning of their placement in the out of area program.

As shown in FIG. 8, nine students have executed the contract on February 7, after having received sufficient referral such that receiving one additional out of area referral will result in the student being placed in the out of area program.

Additionally, the names of all students placed into the out of area program can be communicated to the entire school each morning such as through the schools audio or other announcement system. For example, in one embodiment the names of students placed on the out of area program can be announced over an audio announcement system at a time prior to the beginning of the lunch period. Such as 2 to 3 minutes before the end of the period immediately preceding the schools scheduled lunch period.

Placing the student in an out of area program can be placed for a placement period (a predetermined number of days) in an alternative lunchroom program. The alternative lunchroom program includes a separate and isolated lunchroom location that is designated to isolate the out of area program students from the other students. Such a lunchroom program includes a limited lunch and drink selection and does not allow food from home to be brought in by the students.

In one embodiment, a placement period will initially be 5 consecutive school days for the first instance of the student being placed in the out of area program for a particular defined period of time (such as a school year or semester or term). In some embodiments, a placement of a student in the out of area program for a second or subsequent placement period following the initial placement period will be for an extended period of time such as 10 school days.

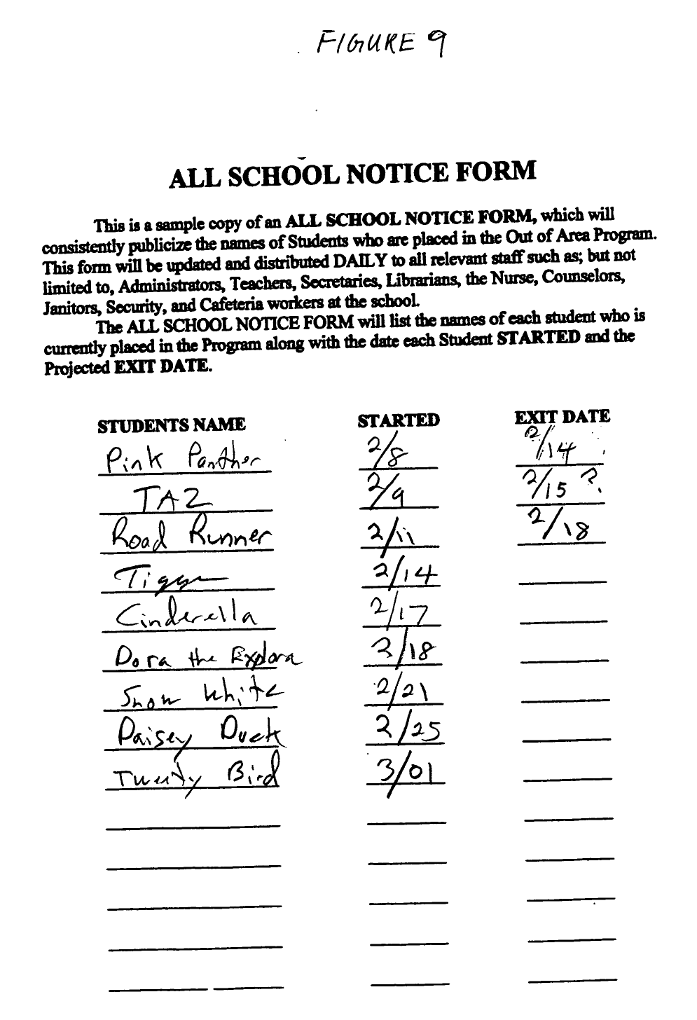

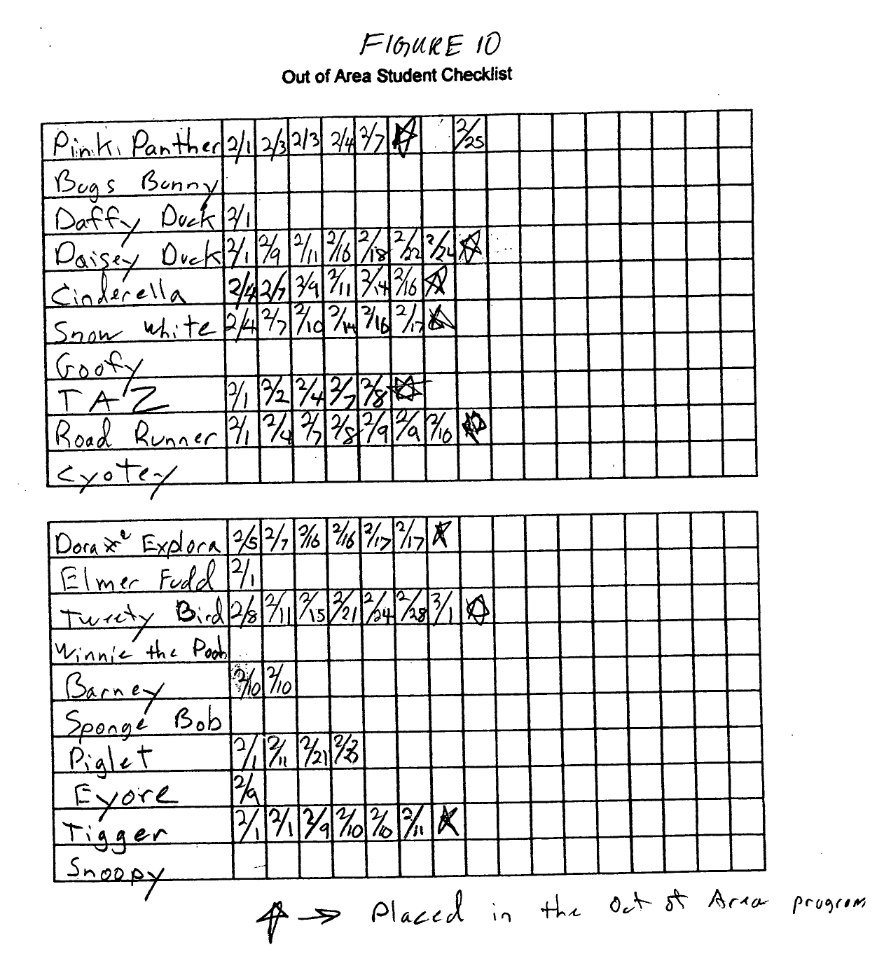

In other embodiments of the invention, a list (such as daily) of all students placed in the out of area program is generated and provided to all school administrators, students, and staff as being placed on the out of area program. FIG. 10 illustrates one example of an out of area student checklist and FIG. 9 illustrates one example of an all school notice form. As shown in FIG. 9, nine students have been placed on the out of area program and are identified in the all school notice form of FIG. 9. As shown, the Pink Panther started the program on February 8 and was released on February 14. Similar entrees have been indicated for the other students placed on the out of area program, with some students continuing in the program. This all school notice form is provided to all staff at the school to ensure that all staff members know who is currently placed in the out of school program.

The all school notice form is provided to all school personnel at the beginning of each day or for the following day and lists all students who are in the out of area program for the identified day. This form provides for consistent identification and evaluation of all students in the out of area program by all personnel. In another form, all school notice form can include the entry and exit date for each student.

Various embodiments of the invention provide for evaluating the students daily for their performance in the out of area program including generating a evaluation for each day a student is in the out of area program that is in one embodiment a pass/fail evaluation. The evaluation or scoring criteria can be any scoring system or method.

One such scoring method, by way of example only, will now be described. A student's participation in the “out of area” program is evaluated and scored every day while placed. Each student is given a passing (P) or a failing (F). Student's score is based on their participation, pleasantness, and no referrals during their placement. A neutral grade (N) could/may be implemented as a behavioral bargaining tool if and/or when needed.

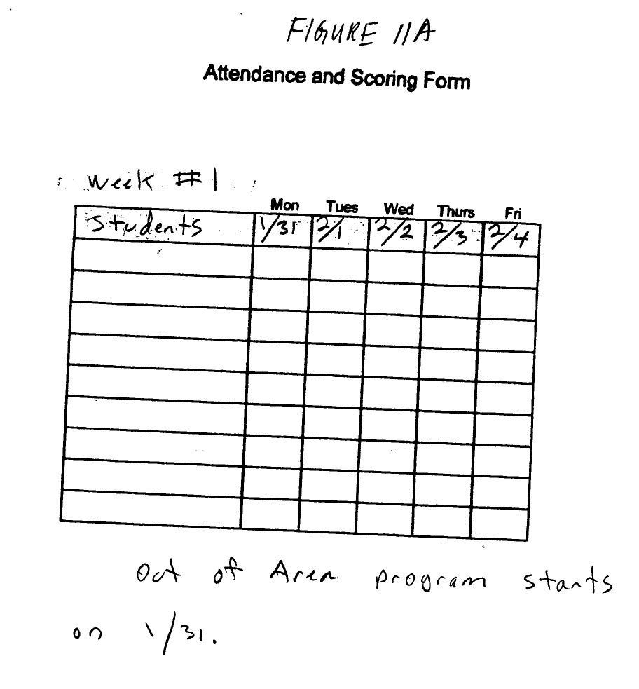

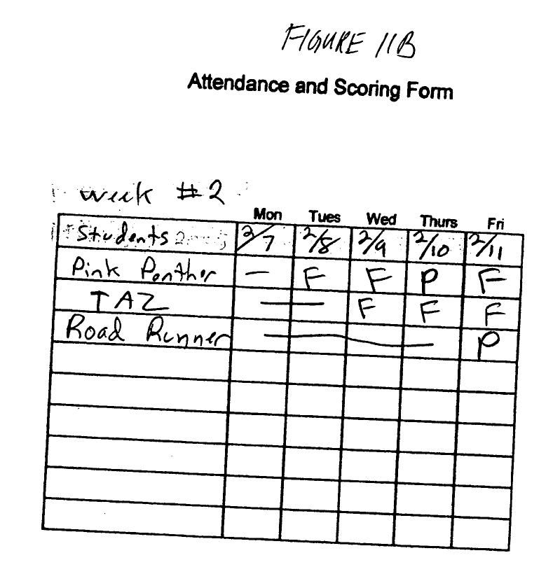

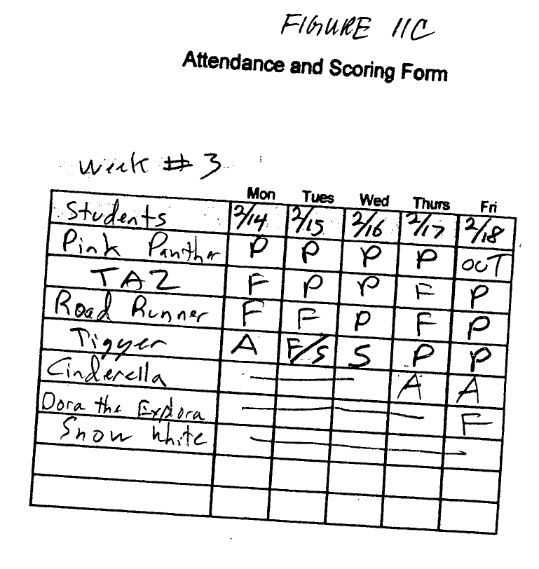

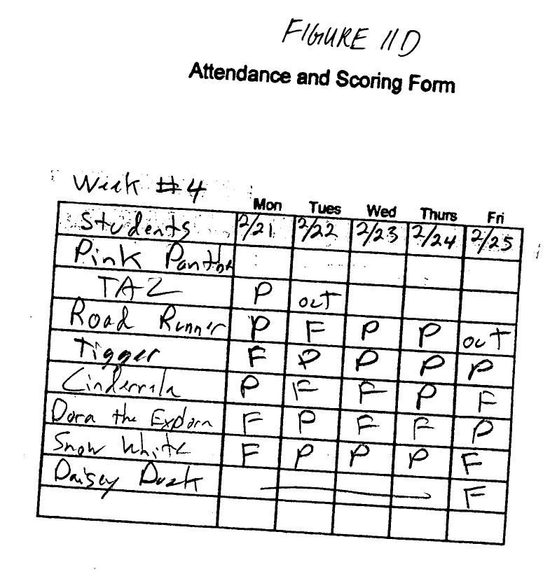

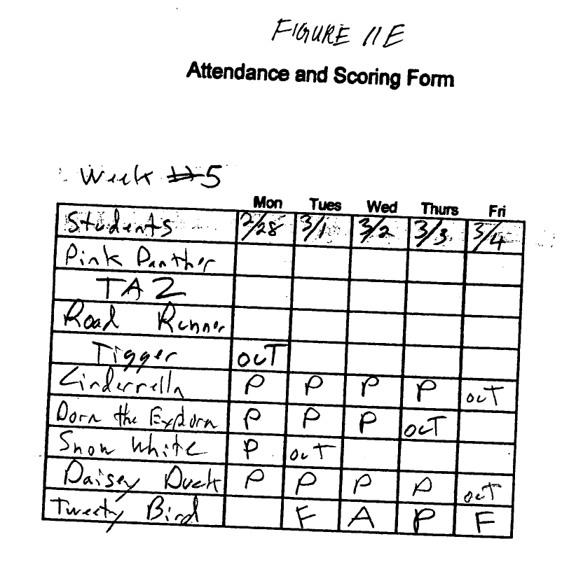

FIGS. 11A to 11E illustrate exemplary embodiments of an out of area program attendance and scoring form for a five week period. As shown in FIG. 11A no students are listed on the form. In week two of this period, as in FIG. 11B three students were place in the out of area program and each has been graded or received an evaluation such as a pass or a fail for each day in the program. In week three as shown in FIG. 11C additional students have been placed in the program and Pink Panther was released from the program as indicated by “out” after having received four consecutive passing grades. In FIG. 11D or week 4, additional students receive the requisite number of consecutive passing grades and are released. Others remain in the out of area program. In FIG. 11E, Tigger, Cinderella, and Daisy Duck are released after having received sufficient consecutive days of receiving a passing grade in the out of area program. FIGS. 11A to 11E are just examples of one five week period and one form for evaluating students who have been placed in the out of area program.

The lunch room supervisor monitors the daily alternative lunch room periods. The lunchroom monitor is responsible for taking attendance and scoring each student's participation daily during the alternative lunch period. The staff will acquire and keep, not only daily scores, but weekly, monthly and annual records along with other “out of area” documentation.

Passing or failing scores is determined by the lunch room supervisor. If and/or when a student acquires a failing daily score, the reason, purpose, and/or the cause of the failing score is documented on the bottom of the daily scoring form of FIG. 11 and is available for review by the student, parents/guardians upon request.

A neutral (N) score may be given in the case of a borderline behavior issue and/or if a neutral score is in the best interest of the program (over crowding).

The first time a student is placed in the program, the students spends a minimum of five lunch periods in the alternative lunch room and/or unless the supervisor and/or the school administration decides otherwise. Students must score five consecutive passing scores.

Based on students needs, an increased number of lunch periods to be served in the alternative lunch room by the students if and/or when they are placed a second time in the “out of area” program. As is discussed below, a behavioral modification scaled system and method is implemented for students who repeatedly demonstrate “out of area” behaviors. The alternative lunch room is located in a selected room.

A policy for phone calls and/or parent/guardian contacts regarding referrals and placement is discussed in congruence with your district's disciplinary codes and then approved by staff.

The Expectations of the students while they are in the out of area program should be discuss with the students by the school staff based on appropriate guidelines developed consistent with the school's policies and procedures.

The name of each student who is spending their lunch period in the alternative lunch room is announced over the intercom prior to the appropriate dismissal bell. Therefore, no students should argue that they were unaware of their placement.
1. All students are expected to arrive on time.
2. All students are directed by staff to a designated area or chair, which is clearly identified and marked.
3. All students are expected to remain in their assigned eating area during the entire lunch period.
4. Students are dismissed by staff at the end of the lunch period.
5. Students who arrive appropriately are allowed to select their sandwich and drink.
6. Each student is responsible for disposing of their own accumulation of trash accordingly and/or as instructed by staff.
7. Typical lunch room and class room rules are expected to be followed by each student and are enforced by staff.

The targeted behavior is “out of area.” Since the desired behavior is area, the following behaviors can initially be allowed, but can be withdrawn as determined by the out of area program supervisor. Students have been referred to this room and will not want to be in there. As an incentive for good behaviors during lunch, the following can be intended to establish positive cooperation between staff and students.
1. Students may be allowed to talk and/or socialize with each other appropriately.
2. Students who arrive first may be allowed to select a desk as their assigned area.
3. Students may be allowed to sit where they want.
4. Staff will always have the option of instructing a student to move. If the student chooses not to move as instructed in a timely manner, a failing score is given.

However, generally the alternative lunchroom should be as boring and uncomfortable as possible, and far away from normal cafeteria or other school or student activities. For example, a room with no windows would be very desirable.

All students placed in the out of area program, are required to arrive to the out of area program lunchroom on time, stay within their assigned or designated area or seat until dismissed, shall not be allowed to acquire additional out of area referrals, and substantially meet the Student Expectations as discussed herein.

In particular, when a student is in out of area program, they will automatically receive a failing grade or evaluation for the day when the student demonstrates an out of area behavior or an out of area incident occurs. Additionally, the placement period is extended by another day.

During the out of area program, students who voluntarily comply with and support the out of area program during their placement may be granted a privilege. For example, when a student attends the out of area program and voluntarily complies with the instructions and requirements of the out of area program can receive preferential treatment such as a first or priority choice of lunch or choice of a drink. In some out of area programs, the lunch menu is extremely limited, such as a predetermined type of sandwich and a limited selection of drinks.

In one exemplary embodiment of an out of area program that includes an alternative lunchroom can utilize three staff personnel, however, the number of required or desired staff is a function of the number of students in the school and/or in the out of area program on any given day or other period of time. In one exemplary embodiment, a first staff member is dedicated to supervise the out of area program lunchroom. The staff member monitors the out of area program lunchroom daily and observes the students and generates the daily out of area program evaluation or grade for each placed student. This staff member can also be responsible for acquiring the lunches for the lunchroom based on the expected number of students for each day.

An out of area program or alternative lunch program staff supervisor can be responsible for monitoring student attendance and evaluate and score each student's participation in the alternative lunch room. Other duties of the lunch program supervisor can include one or more of the following:
1. Acquire a key and unlock—lock and prepare the lunch room daily.
2. Acquire the correct number of lunches plus at least one extra lunch than the number of students from the cafeteria contact person prior to lunch period.
3. Notify the students of their “out of area” referrals and placement whenever possible.
4. Ensure that each placed student receives notification of his placement at least one day prior to their placement and/or at least one day in advance by staff accordingly.
5. Ensure that each student's name is announced over the intercom 2-3 minutes prior to the end of the prior to the lunch period.
6. Record student's attendance and score their participation as passing or failing. An illustration of the pass/fail score form is illustrated in FIG. 11.
7. Acquire the list of students who have been placed in the program and distribute copies of the list to the following but not limited to personal, administration, cafeteria liaison, security liaison, office secretaries, nurses, counselors and any involved staff accordingly.
8. Ensure all staff and students have 100% full knowledge of the out of area program.

A second staff member can be on-call to assist the first staff member in case of an increase in the number of students or the number of students placed in the out of area program being greater than a predetermined number. Additionally, the second staff member can assist with supportive administrative duties such as obtain supplies (such as identified below) or as a substitute for the first staff member. This staff member can also be responsible for reviewing student records and preparing for the recognition/awards portion of the program as described above.

A designated staff person can assist when needed in the lunch room and/or during the out of area program. This can include, when the supervisor is unable to monitor the lunch room, this “on-call” staff person will assume duties accordingly, when the alternative lunch room attendance consists of 6-10 or more students, this staff person will assist during the lunch period, or the second designated staff person can also help acquire the lunches, read students names over the intercom and/or provide any other support when needed.

Another staff member can assist with record keeping and perform other support administrative duties. This can include, but is not limited to, collecting out of area referrals, compiling reports, entering student and out of area, out of area program data into a computer system, generating reports, etc. This can include preparation of the Student Checklist as illustrated in FIG. 10. This can be a master copy of all students and communicating with appropriate staff members regarding the placement of particular students on the out of area program as described above. As shown in FIG. 10 a plurality of students have out of area referrals next to their name, except for Bugs Bunny, Goofy, Winnie the Pooh, and Snoopy who have had not received an out of area referral between the period of February 1 and February 25. The star indicates the date a student was placed into the out of area program after having received out of area referrals in excess of an out of area threshold number.

The support staff person can record, collect and keep data such as, but not limited to, the following:
1. Tally of students who have been discovered “out of area” which will include documentation of when, where and which staff marked the students “out of area”.
2. Pick up and possibly order the lunches from the cafeteria. Cafeteria workers are more than happy to assist in any way with this program and they request that we provide to them the number of lunches one hour in advance.
3. Make 6-8 copies of the students placed in the program for security, cafeteria, administration and team records.

In one embodiment of an out of area program the following recommended supplies could be provided and utilized by school staff. As noted above, an out of area hall pass can be provided to each teacher and/or classroom. These can vary substantially between schools, but can include, at least in some embodiments, in the out of area hall pass that is larger than capable of being hidden or stored in a school locker. The out of area hall pass can be color coded to designate the floor or the team of the teacher and therefore the student possessing the out of area hall pass. In some embodiments, the out of area hall pass can be a form such as illustrated in FIG. 5, by way of example that can be attached to a clipboard that is colored and sized as described above. In such embodiments, clipboards should be procured and distributed to teachers or classrooms for holding the out of area hall passes.

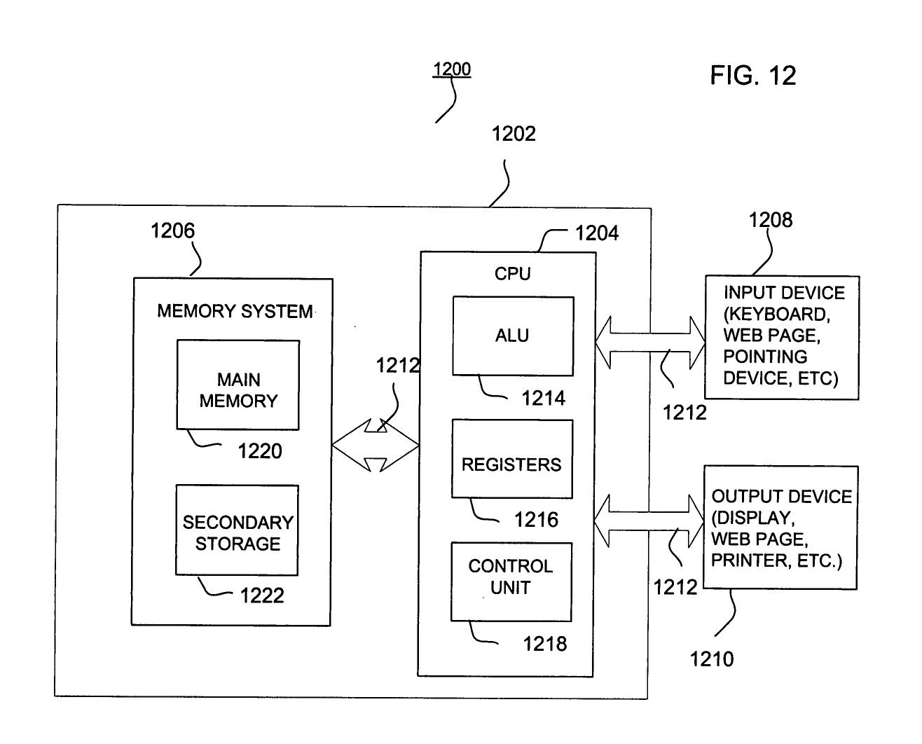

A binder can be used to file weekly out of area program attendance and evaluation or grading forms. Additional binders or files to be procured and administered can include an out of area referral file, student out of area quizzes, student contracts, parent/guardian contacts, and other documents as discussed herein or as identified and required by the school staff. In an alternative embodiment, a computer system (as described below and illustrated in FIG. 12) can be provided for entering in such data, tracking student progress and evaluations, and for generating reports as discussed herein.

A food transportation system or process will have to be developed or provided for transporting the required food and drinks from the school cafeteria to the out of area program lunchroom. Such transportation system should be sized to accommodate the number of students placed in the out of area program each day. The food for the out of area program should be standardized and very limited in selection. For example, the food can consist of a single sandwich and milk for each student placed in the out of area program.

A plurality of out of area referral forms (such as FIG. 4, by way of example) should be procured and distributed to all school staff. Other forms as described herein can also be generated by the above identified computer system or can be procured from a supplier.

An out of area program lunchroom can be identified and reserved for each school day. This room should be isolated from the standard school lunchrooms or places where students typically socialize or have their lunch. In practice, it should be in a close proximity to the lunchroom to aid in the receipt of the above food transportation system.

In some embodiments of the invention the method provides for removing the student from the out of area program when the student achieves a predetermined release evaluation grade which can in some cases be receiving a passing grade for a predetermined number of days such as four out of five days having a passing grade for the initial placement period. For a second or subsequent placement, additional passing grade days can be required before the student is removed from the out of area program. In one preferred embodiment, the number of passing grade days can be a consecutive number of days within the placement period. In such embodiments, the placement period can be extended until the required number of consecutive passing days is achieved by the student.

Some embodiments of the invention address the importance of increasing the consequences for students who demonstrate continuous out of area behavior.

a. The placement period of a student can be extended when the student fails to attend the out of area program as proscribed when within the predetermined number of alterative lunchroom days or when receiving an out of area referral while placed on the out of area program.

b. When a student is placed in the out of area program a second time, their placement period should be extended, for example should be twice that of the first placement. If a student is placed a third time, the placement period should be even longer, possibly three times the initial placement period. At this point, consideration can be given to a permanent placement of the repeat offending student.

b. In the alternative, the student can be placed on out of school suspension if the student fails to attend the out of area program or receiving two or more out of area referrals in one day while they are placed on the out of area program.

c. When a student returns from out of school suspension due to their failure in the out of area program, the student is again placed back into the out of area program and their out of area program placement period resumes as prior to their suspension. The placement period could be the same or could include additional days.

Referring now to FIG. 12, an educational system according to some embodiments of the invention can include an operating environment that is configured to support and implementation of one or more processes and methods of the present invention. This system can include an educational system 1200 with a computer 1202 that comprises at least one high speed processing unit (CPU) 1204, in conjunction with a memory system 1206, an input device 1208, and an output device 1210. The output device 1210 can include a reporting component (not shown) that could be a printer or a data communication link configured to provide written or electronic formatted reports. These elements are interconnected by at least one bus structure 1212.

The illustrated CPU 1204 is of familiar design and includes an arithmetic logic unit (ALU) 1214 for performing computations, a collection of registers 1216 for temporary storage of data and instructions, and a control unit 1218 for controlling operation of the educational system 1200. Any of a variety of processors, including at least those from Digital Equipment, Sun, MIPS, Motorola, NEC, Intel, Cyrix, AMD, HP, and Nexgen, is equally preferred for the CPU 1204. The illustrated embodiment of the invention operates on an operating system designed to be portable to any of these processing platforms.

The memory system 1206 generally includes high-speed main memory 1220 in the form of a medium such as random access memory (RAM) and read only memory (ROM) semiconductor devices, and secondary storage 1222 in the form of long term storage mediums such as floppy disks, hard disks, tape, CD-ROM, flash memory, etc. and other devices that store data using electrical, magnetic, optical or other recording media. The main memory 1206 also can include video display memory for displaying images through a display device. Those skilled in the art will recognize that the memory 1206 can comprise a variety of alternative components having a variety of storage capacities.

The input and output devices 1208, 1210 are also familiar. The input device 1208 can comprise a keyboard, a mouse, a physical transducer (e.g. a microphone), etc. The output device 1210 can comprise a display, a printer, a transducer (e.g. a speaker), etc. Some devices, such as a network adapter or a modem, can be used as input and/or output devices.

As is familiar to those skilled in the art, the educational system 1200 further includes an operating system and at least one application program (not shown in FIG. 12). The operating system is the set of software which controls the computer system's operation and the allocation of resources. The application program is the set of software that performs a task desired by the user, using computer resources made available through the operating system. Both are resident in the illustrated memory system 1206.

In accordance with the practices of persons skilled in the art of computer programming, the present invention is described below with reference to symbolic representations of operations that are performed by the educational system 1200. Such operations are sometimes referred to as being computer-executed. It will be appreciated that the operations which are symbolically represented include the manipulation by the CPU 1204 of electrical signals representing data bits and the maintenance of data bits at memory locations in the memory system 1206, as well as other processing of signals. The memory locations where data bits are maintained are physical locations that have particular electrical, magnetic, or optical properties corresponding to the data bits. The invention can be implemented in a program or programs, comprising a series of instructions stored on a computer-readable medium. The computer-readable medium can be any of the devices, or a combination of the devices, described above in connection with the memory system 1206.

According to one aspect of the invention, the educational system 1200 can provide for evaluating a student for placement in an out of area program and can include a computer 1202 having a processor 1204, a memory 1206, an input device 1208, and an output device 1210 that can include a reporting component. The system 1200 can also include means for evaluating a student's behavior against a set of out of area behavior criteria. The system also includes means for preparing an out of area referral as a function of the evaluating. The computer 1202 is configured to receive and store the prepared out of area referral, sum a plurality of the stored out of area referrals for the student, compare the summed out of area referrals for the student against an out of area program threshold, and designate the student for placement in an out of area program as a function of the summed out of area referrals being equal to or greater than the out of area program threshold. Such as system 1200 can also include the computer 1202 being configured such that the reporting component of the computer is configured to generate at least one of a printed report or an electronic report identifying the out of area referral. In other embodiments, the educational system 1200 can include the computer 1202 being configured to designate the student for placement in the out of area program by at least one of generating a notification message to a user of the computer 1202 or generating a report indicating the designated student.

According to another aspect of the invention, an educational system 1200 provides for addressing disruptive behavior of a student and includes a computer 1202 having a processor 1204, a memory 1206, an input device 1208, and an output device 1210 that can include a reporting component. The system 1200 can also include a means for evaluating a student's behavior against a set of out of area behavior criteria. The system 1200 also includes means for preparing an out of area referral as a function of the means for evaluating, means for placing the designated student in the out of area program for a placement period. The system 1200 further includes means for evaluating the performance of the placed student during the out of area program and means for removing the placed student from the out of area program when the student's evaluation is equal to a removal threshold. The computer 1202 is configured to receive and store the prepared out of area referral, sum a plurality of the stored out of area referrals for the student, compare the summed out of area referrals for the student against an out of area program threshold, and designate the student for placement in an out of area program as a function of the comparing the summed out of area referrals being equal to or greater than the out of area program threshold. The system 1200 can also include the computer 1202 being configured to designate the student for placement in the out of area program as a function of the summed out of area referrals being equal to or greater than the out of area program threshold.

When describing elements or features of the present invention or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described.

Those skilled in the art will recognize that various changes can be made to the exemplary embodiments and implementations described above without departing from the scope of the invention. Accordingly, all matter contained in the above description or shown in the accompanying drawings should be interpreted as illustrative and not in a limiting sense.

It is further to be understood that the processes and/or methods or any steps thereof described herein are not to be construed as necessarily requiring their performance in the particular order discussed or illustrated. It is also to be understood that additional or alternative steps may be employed.

What is claimed is:

1. An educational system for evaluating a student for placement in an out of area program, the system comprising:
a computer having a processor, a memory, an input device, and a reporting component;
means for evaluating a student's behavior against a set of out of area behavior criteria; and
means for preparing an out of area referral as a function of the evaluating;
wherein the computer is configured to receive and store the prepared out of area referral, sum a plurality of the stored out of area referrals for the student, compare the summed out of area referrals for the student against an out of area program threshold, and designate the student for placement in an out of area program as a function of the summed out of area referrals being equal to or greater than the out of area program threshold.

2. The system of claim 1 wherein the reporting component of the computer is configured to generate at least one of a printed report or an electronic report identifying the out of area referral.

3. The system of claim 1 wherein the computer is configured to designate the student for placement in the out of area program by at least one of generating a notification message to a user of the computer or generating a report indicating the designated student.

4. An educational system for addressing disruptive behavior of students, the system comprising:
a computer having a processor, a memory, an input device, and a reporting component;
means for evaluating a student's behavior against a set of out of area behavior criteria;
means for preparing an out of area referral as a function of the means for evaluating;
means for placing the designated student in the out of area program for a placement period;
means for evaluating the performance of the placed student during the out of area program; and
means for removing the placed student from the out of area program when the student's evaluation is equal to a removal threshold,
wherein the computer is configured to receive and store the prepared out of area referral, sum a plurality of the stored out of area referrals for the student, compare the summed out of area referrals for the student against an out of area program threshold, and designate the student for placement in an out of area program as a function of the comparing the summed out of area referrals being equal to or greater than the out of area program threshold.

5. The system of claim 4 wherein the computer is configured to designate the student for placement in the out of area program as a function of the summed out of area referrals being equal to or greater than the out of area program threshold.

6. A method of evaluating students for placement in an out of area program, the method comprising:
evaluating a student's behavior against a set of out of area behavior criteria;
preparing an out of area referral as a function of the evaluating;
storing the prepared out of area referral;
summing a plurality of the stored out of area referrals;
comparing the summed out of area referrals for the student against an out of area program threshold; and
designating the student for placement in an out of area program as a function of the summed out of area referrals being equal to or greater than the out of area program threshold.

7. The method of claim 6 wherein preparing the out of area referral includes submitting a report indicating the out of area incident.

8. The method of claim 6 wherein storing the prepared out of area referral includes inputting the prepared out of area referral into a computer configured for out of area data management and having a memory for storing the out of area referral.

9. The method of claim 6 wherein the out of area program threshold is five out of area referrals.

10. The method of claim 6, further comprising establishing the set of out of area behavior criteria.

11. The method of claim 6, further comprising presenting the student with material covering the out of area criteria and out of area program and offering a quiz to the student covering the presented material.

12. The method of claim 11, further comprising repeating the presenting and the offering until the student achieves a 100 percent score on the quiz.

13. The method of claim 6, further comprising presenting the student designated for placement in the out of area program with a contract that acknowledges the student's pending placement in the out of area program and receiving the presented contract after being signed by the student.

14. The method of claim 6 wherein the out of area program is an alternative lunchroom program.

15. The method of claim 6, further comprising providing each teacher in the school with a hall pass configured such that is at least one of oversized, sized not fit within a student locker, and marked to indicate an origin.

16. A method for addressing disruptive behavior of a student comprising:
evaluating a student's behavior against a set of out of area behavior criteria;
designating the student for placement in an out of area program as a function of the evaluation of the student's behavior;
placing the designated student in the out of area program for a placement period;
evaluating the performance of the placed student during the out of area program; and
removing the placed student from the out of area program when the student's evaluation is equal to a removal threshold.

17. The method of claim 16 wherein designating the student for placement in an out of area program includes storing the prepared out of area referral, summing a plurality of stored out of area referrals; and comparing the summed out of area referrals for the student against an out of area program threshold, wherein designating the student for placement in the out of area program is a function of the summed out of area referrals being equal to or greater than the out of area program threshold.

18. The method of claim 17 wherein the out of area program threshold is five out of area referrals.

19. The method of claim 16 wherein evaluating the performance of the placed student includes judging the performance of the student against a set of out of area program criteria and allocating a grade of at least one of a pass or a fail to the student for each day during the placement period.

20. The method of claim 19 wherein the placement period for a first placement of the student in the out of area program is five school days.

21. The method of claim 20 wherein the removal threshold is four consecutive days with the allocated grade for each day being a pass.

22. The method of claim 20 wherein the placement period for a second placement of the student in the out of area program is ten school days.

23. The method of claim 16 wherein the out of area program is an alternative lunchroom program.

24. The method of claim 16, further comprising removing the designated student's hall pass privileges during the placement period.

25. The method of claim 16, further comprising providing each teacher in the school with a hall pass configured such that is at least one of oversized, sized not fit within a student locker, and marked to indicate an origin.

26. The method of claim 16, further comprising presenting the student with material covering the out of area criteria and out of area program and offering a quiz to the student covering the presented material.

27. The method of claim 16, further comprising presenting the student designated for placement in the out of area program with a contract that acknowledges the student's pending placement in the out of area program and receiving the presented contract after being signed by the student.

28. A method of motivating a student to improve behavior and attitude, the method comprising:
establishing an out of area behavior criteria;
evaluating a student's behavior against the out of area behavior criteria;
preparing an out of area referral as a function of the evaluating;
tracking the out of area referrals for the student;
recognizing a student for receiving fewer out of area referrals over a recognition time period than a recognition quantity;
designating the student for placement in an alternative lunchroom program as a function of the tracking of the out of area referrals;
placing the designated student in the alternative lunchroom program for a placement period;
evaluating the performance of the placed student during the alternative lunchroom program; and
removing the placed student from the alternative lunchroom program when the student's evaluation is equal to a removal threshold.

29. The method of claim 28, further comprising providing each teacher in the school with a hall pass configured such that is at least one of oversized, sized not fit within a student locker, and marked to indicate an origin.

30. The method of claim 28, further comprising presenting the student with material covering the out of area criteria and out of area program and offering a quiz to the student covering the presented material.

31. The method of claim 28, further comprising presenting the student designated for placement in the out of area program with a contract that acknowledges the student's pending placement in the out of area program and receiving the presented contract after being signed by the student.

32. The method of claim 28, further comprising providing each teacher in the school with a hall pass configured such that is at least one of oversized, sized not fit within a student locker, and marked to indicate an origin.

33. The method of claim 28 wherein designating the student for placement in an out of area program includes storing the prepared out of area referral, summing a plurality of stored out of area referrals; and comparing the summed out of area referrals for the student against an out of area program threshold, wherein designating the student for placement in the out of area program is a function of the summed out of area referrals being equal to or greater than the out of area program threshold.

34. The method of claim 32 of wherein evaluating the performance of the placed student includes judging the performance of the student against a set of out of area program criteria and allocating a grade of at least one of a pass or a fail to the student for each day during the placement period.

35. The method of claim 32, further comprising removing the designated student's hall pass privileges during the placement period.
